(19) United States
(12) Patent Application Publication
(10) Pub. No.: US 2025/0001340 A1
(43) Pub. Date: Jan. 2, 2025

(54) CERAMIC FILTER AND CONTAINER FOR LIQUIDS COMPRISING SAID CERAMIC FILTER

(71) Applicant: IDRA WATER S.R.L., Avigliana (Torino) (IT)

(72) Inventors: Fabrizio BOSCOLO, Avigliana (Torino) (IT); Valentina VECCHIA, Leini' (Torino) (IT)

(21) Appl. No.: 18/709,082

(22) PCT Filed: Nov. 10, 2022
(86) PCT No.: PCT/IB2022/060812

§ 371 Date: May 10, 2024

(30) Foreign Application Priority Data
Nov. 11, 2021 (IT) 102021000028679

(51) Int. Cl. B01D 39/20; B01D 35/28; B01D 39/16; B01D 39/18; B01D 41/04; B08B 3/08; C04B 33/04; C04B 33/13; C04B 33/30; C04B 33/32; C04B 41/45; C04B 41/51; C04B 41/88

(52) U.S. Cl. CPC B01D 39/2068; B01D 35/28; B01D 39/1646; B01D 39/18; B01D 39/2027; B01D 41/04; B08B 3/08; C04B 33/04; C04B 33/1305; C04B 33/131; C04B 33/30; C04B 33/32; C04B 41/4539; C04B 41/5116; C04B 41/88; B01D 2239/0442; B01D 2239/1208; B08B 2203/007; C04B 2235/3472; C04B 2235/349; C04B 2235/604

(57) ABSTRACT

A ceramic filter including composite material having a porosity comprised between 0.1 μm and 10 μm is provided. A process for cleaning the ceramic filter, a process for producing the ceramic filter and a container for liquids including the ceramic filter are also provided. Advantageously, the ceramic filter, the process for cleaning the ceramic filter, the process for producing the ceramic filter and the container for liquids comprising the ceramic filter help people live a healthier lifestyle, through non-disposable but long-lasting products, promoting consumption of tap water and eliminating 100% of plastics. The ceramic filter and the container for liquids comprising the ceramic filter advantageously give people the possibility of drinking pure, good and safe water, producing zero waste, through sustainable, long-lasting and completely plastics-free products.

### FIELD OF THE INVENTION

The present invention relates to a ceramic filter, a process for cleaning said ceramic filter, a process for producing said ceramic filter, and a container for liquids comprising said ceramic filter.

### PRIOR ART

Plastics pollution has become one of the most pressing environmental issues: the production of disposable plastics objects is overwhelming the ability to manage it. This type of pollution is most evident in developing nations in Asia and Africa, where waste collection systems are often inefficient or non-existent. But even the developed world, and especially countries with low recycling rates, are having their own problems in correctly managing plastics that has become waste. This type of garbage is becoming so ubiquitous that a global agreement negotiated by the United Nations has been drafted.

The production and consumption of water bottled in plastics bottles are two factors that have a heavy impact on plastics pollution.

From the 1980s onwards, and above all in the last ten years-also due to the enrichment of the population in developing countries-the consumption of bottled water has increased dramatically all over the world. In these rankings, Italy ranks first in Europe and third in the world, with 188 liters per year consumed in 2017, against a European average of 117, and 206 liters in 2018. Before Italy are only Mexico, where, according to data from the World Health Organization, in 2015 only 43% of the population had access to safe running water, and Thailand, where this guarantee was limited to 47% of the population. In total, 46 billion plastics bottles are consumed annually in the 28 EU countries, with between 7.2 and 8.4billion in Italy.

The possibility of having production and consumption of bottled water not in plastics bottles is therefore a need felt on the market.

The possibility of helping people to live a healthier lifestyle by creating non-disposable but long-lasting products, promoting the consumption of tap water and eliminating 100% of plastics is another need felt on the market. As is giving people the opportunity to drink pure, good and safe water by producing zero waste, using sustainable, long-lasting and completely plastics-free products.

### SUMMARY OF THE INVENTION

The object of the present invention is therefore to provide products for the production and consumption of bottled water not in plastics bottles, but through sustainable, reusable, long-lasting and completely plastics-free products.

This object is achieved by a ceramic filter, a process for cleaning said ceramic filter, a process for producing said ceramic filter, and a container for liquids comprising said ceramic filter as outlined in the appended claims, the definitions of which form an integral part of the present patent application.

### BRIEF DESCRIPTION OF THE FIGURES

The invention will be better understood from the following detailed description of preferred embodiments thereof, given by way of non-limiting example and with reference to the accompanying figures, in which:

FIG. 1 shows a front perspective view of the ceramic filter according to the present invention (FIG. 1A), a bottom perspective view of the ceramic filter according to the present invention (FIG. 1B) and a top perspective view of the ceramic filter according to the present invention (FIG. 1C).

FIG. 2 shows a portion of the filter according to the present invention observed through a stereomicroscope.

FIG. 3 shows a section along a longitudinal plane of the container for liquids according to the present invention.

In the accompanying figures, identical or similar elements are denoted by the same reference signs.

### DETAILED DESCRIPTION OF THE INVENTION

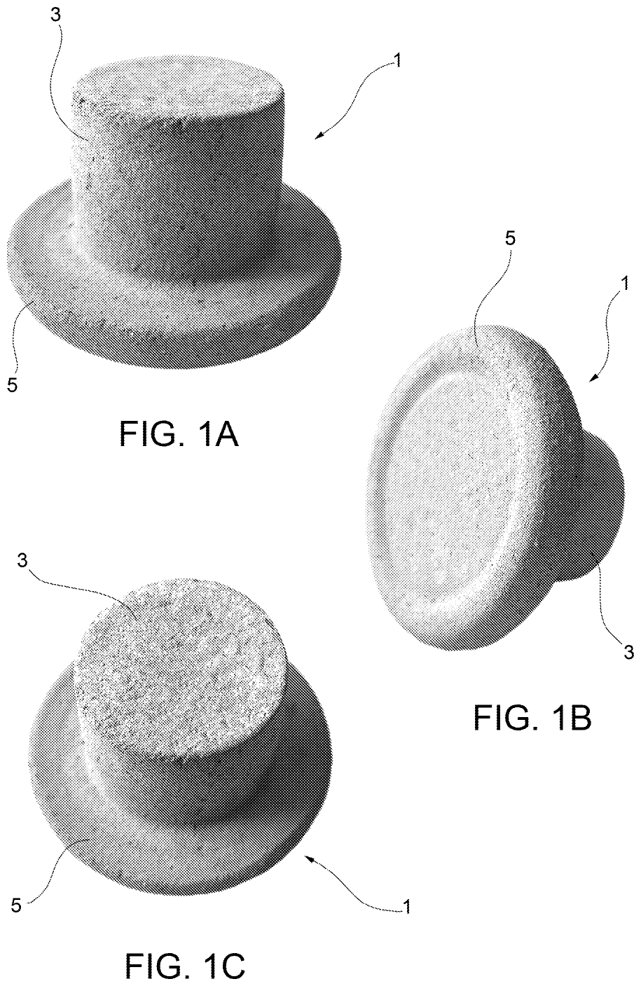

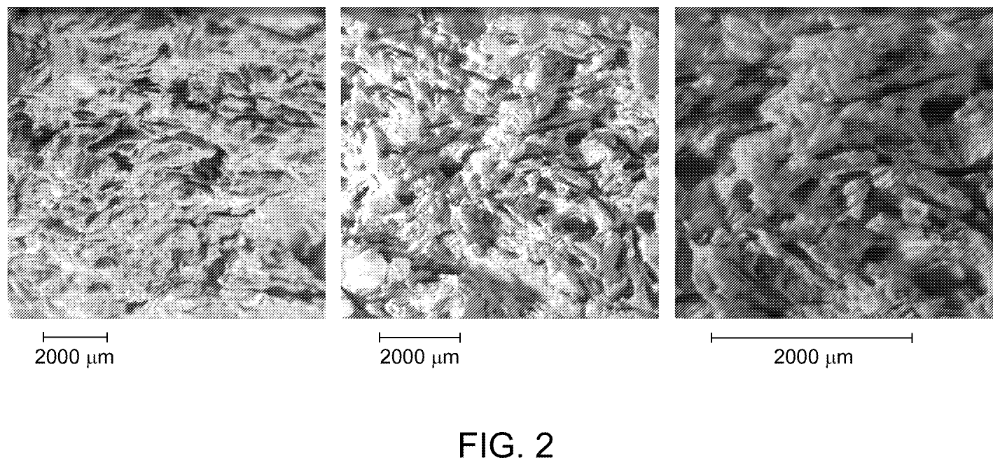

With reference to FIGS. 1 and 2, a first object of the present invention is shown, i.e. a ceramic filter 1 comprising composite material, wherein the composite material has a porosity comprised between 0.1 μm and 10 μm. Preferably, said ceramic filter 1 is a gravity filter, in which filtration takes place mainly, but not exclusively, by exploiting the force of gravity. Preferably, said ceramic filter 1 comprises a first portion 3, preferably with a substantially cylindrical shape, wherein said cylinder comprises a lower base, an upper base, both preferably oval or round in shape, and a side wall preferably with an oval or round section connected both to the upper base and to the lower base. Said ceramic filter 1 also preferably comprises a second portion 5 substantially in the shape of a disc placed perpendicular to the first portion 3.

Preferably, the porosity value of the composite material (FIG. 2) is obtained by measuring the dimensions of the pores visible by virtue of the images obtained with the aid of a stereomicroscope.

The term composite material refers to a heterogeneous material, i.e. consisting of two or more phases with different physical properties, whose properties are much better than those of the phases that constitute it. Usually, the different phases in the composite are made up of different materials, as is the case with carbon fiber and epoxy resin composites. Composite materials may be both artificial and natural. Some examples of naturally occurring composite materials are wood, in which cellulose fibers are dispersed in a lignin phase, and bone, in which collagen is reinforced by mineral apatite.

According to a preferred embodiment of the present invention, the composite material comprises: mixture of semi-refractory clay, ground rice hull or sieved or ground wood sawdust, clinoptilolite, colloidal silver. Rice hull may, in fact, be replaced with previously sieved or ground sawdust. Preferably, the mixture of semi-refractory clay comprises a mixture of clays to which chamotte is added. As known to those skilled in the art, chamotte is a baked and ground refractory clay, used as a slimming agent in ceramic and refractory mixtures.

The term colloidal silver means a liquid compound consisting of tiny particles of silver suspended in purified water (demineralized, distilled or bi-distilled); it is a compound to which antibacterial, antiviral and antifungal properties are attributed.

Preferably, the colloidal silver is in a concentration of between 30 ppm and 50 ppm, even more preferably it is in a concentration of 40 ppm (parts per million).

Advantageously, by virtue of the presence of silver ions and minerals contained in the ceramic filter 1 according to the present invention, the ceramic filter 1 filters and removes 99% of the harmful substances present in a liquid, preferably water, and improves the taste of the liquid, preferably water.

According to an alternative embodiment of the ceramic filter 1 according to the present invention, the above composite material preferably comprises: mixture of semi-refractory clay, calcite, clinoptilolite, colloidal silver.

As known to those skilled in the art, calcite is a mineral made up of calcium carbonate (CaCO₃).

Preferably, said calcite has a grain size of about 1 μm.

In a second aspect, the present invention also relates to a process for cleaning a ceramic filter 1 as described above, comprising the steps of:
providing a ceramic filter 1 as described above;
bringing an acidic aqueous solution to a boiling temperature;
immersing the filter 1 in said acidic aqueous solution brought to a boiling temperature;
leaving the filter 1 immersed in the acidic aqueous solution brought to a boiling temperature for a time comprised between 5 and 10 minutes;
removing the filter 1 from the acidic aqueous solution and allowing it to dry.

Preferably, the acidic aqueous solution is an aqueous solution of citric acid and the boiling temperature is a temperature of between 90° C. and 110° C., even more preferably it is a temperature of 100° C. According to a preferred embodiment of the present invention, the aqueous solution of citric acid is obtained by immersing a slice of lemon in water.

Preferably, the filter 1 is left immersed in the acidic aqueous solution brought to a boiling temperature for a time of 5 minutes.

Preferably, the filter 1 is removed from the acidic aqueous solution and left to air dry at room temperature.

In a third aspect, the present invention also relates to a process for producing a ceramic filter 1 as described above, comprising the steps of:
providing: mixture of semi-refractory clay, ground rice hull or sieved or ground wood sawdust, clinoptilolite;
mixing together water, mixture of semi-refractory clay, ground rice hull or sieved or ground wood sawdust, clinoptilolite, so as to obtain a mixture;
inserting the mixture so obtained inside a mold and, through the press molding technique, obtaining an object;
detaching the object from the mold;
baking the object obtained and detached from the mold at a temperature comprised between 900° C. and 1100° C. for a period of time comprised between 19 hours and 20 hours;
preparing an aqueous suspension of colloidal silver;
immersing the object in the aqueous suspension of colloidal silver;
extracting the object from the aqueous suspension of colloidal silver and allowing it to dry so as to obtain the ceramic filter 1 according to the above description.

Preferably, the mold has a substantially negative shape with respect to that of the ceramic filter 1 (the preferred shape of the ceramic filter 1 has been described in the previous paragraphs). Preferably, the mixture is placed between the two plaster shells of the mold, which are closed by a hydraulic piston. When they reopen, the object is detached by a jet of air passing through the pores of the plaster mold. Preferably, the step of detaching the object from the mold then takes place by means of a jet of air.

Preferably, following the step of detaching the object from the mold, the object undergoes a finishing process.

Preferably, the step of baking the object obtained and detached from the mold takes place at a temperature of 1000° C. and for a period of time of about 19-20 hours.

Preferably, an aqueous suspension of colloidal silver is prepared at a concentration of 40ppm. Advantageously, the suspension is absorbed by the ceramic filter 1 by capillary action and the silver nanoparticles are deposited in the space of the pores. Advantageously, the turbidity and the microbial pathogens possibly present in the liquid (preferably water) to be filtered are removed by physical filtration and chemical disinfection by virtue of the presence of the silver nanoparticles. Silver is a highly effective disinfectant for pathogens present in liquids; in fact, it is able to destroy the cell wall, inhibit bacterial DNA replication and interrupt bacterial respiration.

Preferably, the step of allowing the ceramic filter 1 extracted from the aqueous suspension of colloidal silver to dry takes place in the air and at room temperature.

According to an alternative embodiment of the process for producing a ceramic filter 1 according to the present invention, when the composite material preferably comprises calcite, said process preferably comprises the steps of:
providing: mixture of semi-refractory clay, calcite, clinoptilolite;
mixing together water, a mixture of semi-refractory clay, calcite, clinoptilolite, in order to obtain a mixture;
inserting the mixture so obtained inside a mold and, through the press molding technique, obtaining an object;
detaching the object from the mold;
baking the object obtained at a temperature comprised between 500° C. and 700° C., preferably at 600° C., for a period of time comprised between 8 hours and 12 hours;
immersing the baked object in an acidic solution of acetic acid (CH₃COOH) having a concentration of between 1% and 5%;
backing again the object previously baked and immersed in an acidic solution at a temperature of between 900° C. and 1100° C., preferably at 1000° C., for a period of time of about 19-20 hours;
preparing an aqueous suspension of colloidal silver;
immersing the object in the aqueous suspension of colloidal silver;
extracting the object from the aqueous suspension of colloidal silver and allowing it to dry so as to obtain the ceramic filter 1 according to the above description.

Advantageously, the calcite (calcium carbonate), following the interaction with the acetic acid, dissolves in the calcium ion and in the acetate ion with the development of a molecule of water and one of carbon dioxide, leading to dissolution thereof. By virtue of the dissolution of the calcite, a better distribution of the pores is obtained inside the composite material of the ceramic filter 1 according to the present invention.

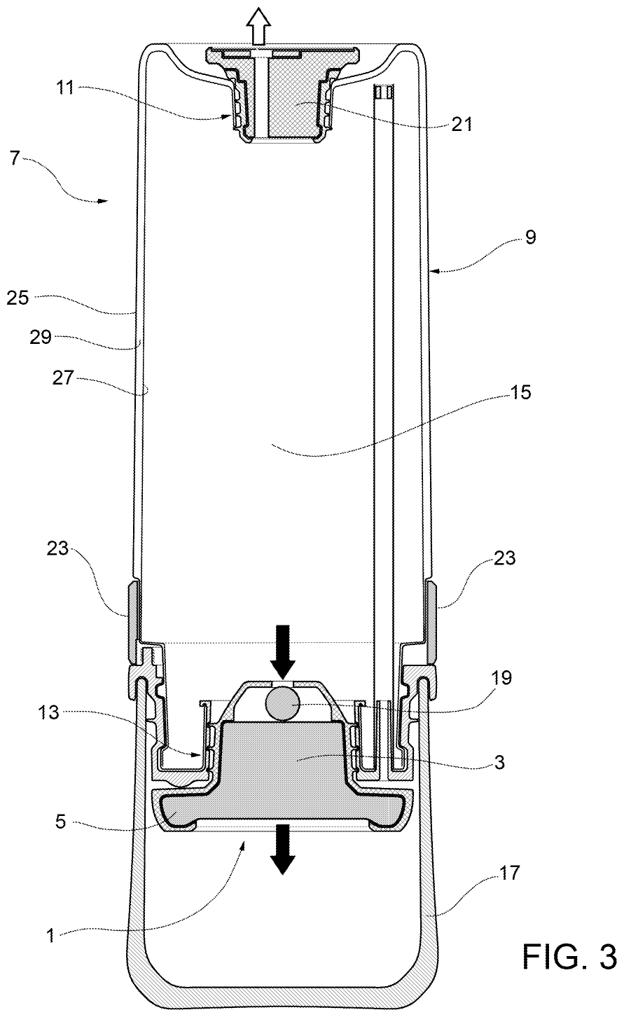

With reference to FIG. 3, a fourth object of the present invention is shown, i.e. a container 7 for liquids comprising a main body 9, comprising in turn at least a first closable opening 11, at least a second closable opening 13, wherein the at least a first closable opening 11 and the at least a second closable opening 13 are fluidically connected by means of a through cavity 15, wherein the at least a second closable opening 13 is closed by a removable ceramic filter 1 according to what has been described above; wherein the container 7 further comprises a hollow receptacle 17 which is functionally attachable and detachable to/from the main body 9 at the at least a second opening 13 closed by said filter 1; wherein, when the hollow receptacle 17 is attached to the main body 9, the at least a second opening 13 and the filter 1 occupy part of the cavity of the receptacle 17.

Preferably, the main body 9 comprises an external side wall 25 surrounding the through cavity 15 and connected to both the at least a first closable opening 11 and to the at least a second closable opening 13. According to a preferred embodiment of the present invention, the main body 9 further comprises an internal side wall 27, placed inside the through cavity 15 and spaced from the external side wall 25 so as to generate an internal chamber 29 between the internal side wall 27 and the external side wall 25. Preferably and advantageously, said internal chamber 29 may be an air chamber so as to make the container 7 for liquids a heat-tight container.

Preferably, the main body 9 is a body having a shape selected from: cylindrical, parallelepiped, oval, irregular (for example bottle-shaped), polyhedral. Even more preferably, the main body 9 has a cylindrical shape.

Preferably, the hollow container 17 is selected from among: glass, cup, bottle, mess tin, vase, pitcher, canteen, carafe, mug. Even more preferably, the hollow container 17 is a glass.

According to a preferred embodiment of the present invention, the removable ceramic filter 1 is coupled to a further ceramic filter comprising calcium sulfite 19, wherein this further ceramic filter comprising calcium sulfite 19 is placed within the through cavity 15.

Preferably, the further ceramic filter 19 comprising calcium sulfite has a shape selected from: spherical, cylindrical, parallelepiped, oval, irregular, polyhedral. Even more preferably, the further ceramic filter 19 comprising calcium sulfite has a spherical shape.

Advantageously, the further ceramic filter comprising calcium sulfite 19 allows 99% of chlorine to be removed in 0.8 seconds, guaranteeing a filtering capacity of 100 liters of liquid, preferably water, per month.

According to a preferred embodiment of the present invention, the at least a first closable opening 11 is closed by a removable cap 21.

Preferably, the cap 21 has a shape complementary to that of the first closable opening 11, for example it has a cylindrical shape if the first closable opening 11 has a cylindrical shape or is simply a circle or oval shaped opening. Preferably, the cap 21 is a metal cap, for example an aluminum cap, or it is a cap 21 made of polymeric material. Preferably, the cap 21 comprises a vent valve, passing along the entire longitudinal section of the cap 21, for any air possibly present in the through cavity 15 to escape outside the cap 21 and therefore outside the container 7 for liquids. Preferably, the cap 21 closes the first closable opening 11 by means of a pressure interaction between the cap 21 and the first opening 11, or by means of an interaction of the screw-bolt type.

According to a preferred embodiment of the present invention, the main body 9 further comprises a rotatable ferrule 23 indicating a sequence of numbers comprised between 1 and 50, preferably a sequence of numbers between 1 and 20. Preferably, the rotatable ferrule 23 is a ferrule which surrounds the main body 9. Preferably, the rotatable ferrule 23 comprises a fixed unit, connected to the main body 9, surmounted by a rotatable unit which slides above the fixed unit. Preferably, a sequence of numbers between 1 and 50 is printed or marked or engraved or written on the fixed unit. Preferably, the sequence of numbers is printed or marked or engraved or written as Arabic numerals, or Roman numerals, or they are numbers indicated using the letters of any alphabet. Preferably, the rotatable unit comprises a hole, in the shape of a semicircle or circle, or polygon or irregular shape, at the sequence of numbers and the hole has such a size that when the hole overlaps one of the numbers of the aforementioned sequence it is possible for a user of the container 7 for liquids (a person for example) to read the number. Preferably, the rotatable unit sliding on the fixed one allows for the correspondence between the hole and one of the numbers of the sequence, so as to allow the numbers of the sequence to be read.

According to a preferred embodiment of the present invention, the filter 1 closes the second closable opening 13 by means of a pressure interaction between the filter 1 and the opening 13, or by means of a screw-bolt type interaction. Preferably, the filter 1 has a shape complementary to that of the second closable opening 13, for example it has a cylindrical shape if the second closable opening 13 has a cylindrical shape or is simply a circle or oval shaped opening.

According to a preferred embodiment of the present invention, the hollow receptacle 17 attaches to the main body 9 of the container 7 for liquids by a pressure interaction between the hollow receptacle 17 and the main body 9, or by a screw-bolt type interaction.

According to a preferred embodiment of the present invention, the main body 9 is made of a material selected from: stainless steel, aluminum, titanium, silicone, ceramic and glass.

According to an alternative embodiment of the present invention, the main body 9 is made of a material selected from: polymer, plastic polymer, copolyester. According to a preferred embodiment of the present invention, both the internal side wall 27 and the external side wall 25 are made of a material selected from: stainless steel, aluminum, titanium, silicone, ceramic and glass. Even more preferably, both the internal side wall 27 and the external side wall 25 are made of stainless steel.

According to a preferred embodiment of the present invention, the hollow receptacle 17 is made of a material selected from: stainless steel, aluminum, titanium, silicone, ceramic and glass. Even more preferably, the hollow container 17 is made of glass.

Advantageously, the choice of stainless steel (preferably 18/8 stainless steel, i.e. stainless steel comprising a concentration of 18% chromium and 8% nickel) stems from the desire to:
preserve the freshness of the liquid (preferably water);
protect the liquid (preferably water) from UV rays;
give the container 7 lightness, hygiene and durability.

Advantageously, the choice of silicone stems from the desire to completely eliminate materials deriving from petroleum, while satisfying the technical and hygienic requirements of the product. Silicone is a polymer made from silica contained in rocks and sand. Silica is one of the most widespread natural resources on earth and is absolutely non-polluting.

Advantageously, the silicone used according to the present invention is recyclable, it is therefore possible to dispose of and recycle it, thus giving it new life, helping to preserve the environment.

Advantageously, the choice of aluminum and glass stems from the desire to use infinitely recyclable materials, with a use of electricity equal to 5% of the energy necessary for the production of these materials.

Advantageously, the container 7 for liquids (preferably water) according to the present invention allows the need of consumers to remember how much water they drink to be met without the need to use applications, such as sound alarms, but through a visual reminder, namely the rotatable ferrule 23.

Advantageously, the container 7 for liquids (preferably water) according to the present invention was created to teach people to drink constantly throughout the day, keeping track of the glasses of water drunk by virtue of the rotatable ferrule 23.

Advantageously, the container 7 for liquids (preferably water) according to the present invention allows consumers to fill their container 7 wherever they are and filter the liquid (preferably water) without the aid of disposable filters.

By way of example, a preferred operation of the container 7 for liquids (preferably water) according to the present invention is schematically indicated below.

Fill: any place where there is liquid, preferably a source of drinking water.

Drink: the container 7 for liquids (preferably water) filters a 236 ml/8 oz glass of liquid (preferably water) every 10/15 minutes to guarantee the daily requirement of liquids (preferably water) of each individual.

Advantageously, the container 7 for liquids (preferably water) according to the present invention has been designed to educate people to drink the right amount of liquids (preferably water) at the right time. Advantageously, by virtue of the rotatable ferrule 23, it is very easy to mark how many glasses of liquid (preferably water) one has already drunk and thus achieve the correct daily hydration.

Regenerate: preferably once a month the ceramic filter 1 should be boiled in water for between 5 and 10 minutes, preferably for 5 minutes, preferably with a slice of lemon to remove limescale and clean the pores of the ceramic filter 1. The further ceramic filter comprising calcium sulfite 19 should preferably be replaced once a month or when 100 liters of filtered liquid (preferably water) are reached. The further ceramic filter comprising calcium sulfite 19 does not, however, lose its properties of eliminating chlorine, it only decreases the capacity thereof. For this reason, the further ceramic filter comprising calcium sulfite 19 may be reused for plants or aquariums in which it favors the absorption of chlorine.

The container 7 for liquids (preferably water) according to the present invention also provides the advantage of being portable and watertight, and of protecting the liquid (preferably water) contained inside the container 7 from UV rays.

The following embodiment examples are provided purely for illustrative purposes of the present invention and should not be interpreted as limiting the scope of protection defined by the accompanying claims.

### EXAMPLE 1

A container 7 for liquids (preferably water) according to the present invention was provided. The through cavity 15 was filled with an aqueous solution of acetic acid at 4% and, following the Official Gazette regulations no. 98 of Apr. 26, 1985 and Official Gazette no. 66 of Mar. 20, 2007, the concentrations of lead (Pb) and cadmium (Cd) present in the aqueous solution of acetic acid at 4% were analyzed after its passage inside the ceramic filter 1 and collection in the hollow receptacle 17.

The following Table 1 shows the results:

TABLE 1
concentration expressed in mg/L of Pb and Cd present in the aqueous
solution of acetic acid at 4% were analyzed after its passage inside
the ceramic filter 1 and collection in the hollow receptacle 17.

| | |
|---|---|
| Pb leachate | <0.1 mg/L |
| Cd leachate | <0.1 mg/L |

### EXAMPLE 2

A ceramic filter 1 according to the present invention was provided. An aqueous solution of acetic acid at 4% was prepared. The ceramic filter 1 was immersed for 24 hours, at a temperature of 22° C., in the aqueous solution of acetic acid at 4%. Following the UNI EN ISO 11885:2009 ICP-OES standard, the concentration of different chemical elements present in the aforementioned solution was analyzed at the end of 24 hours.

The following Table 2 shows the average value of four tests carried out as described above:

TABLE 2
concentration expressed in mg/L (average value of four
tests) of elements present in an aqueous solution of
acetic acid at 4% in which the ceramic filter 1 was
immersed for 24 hours, at a temperature of 22° C.

| | Aqueous solution of acetic acid at 4% |
|---|---|
| | kept in contact with the ceramic filter for 24 hours at 22° C. |
| | (Average value of four tests) |
| Element | Concentration (mg/L) |
| Fe | 13.92 |
| Ca | 413 |
| Mg | 39.61 |
| K | 3.29 |
| Na | 2.31 |
| S | 19.09 |
| Al | 109 |
| Ag | 0.04 |
| As | <0.01 |
| Ba | 1.04 |
| Cd | <0.01 |
| Co | 0.03 |
| Cr | 0.09 |
| Cu | 0.07 |
| Mn | 1.16 |
| Ni | 0.05 |
| Pb | <0.1 |
| Sb | <0.01 |
| Se | <0.01 |
| Sr | 0.93 |
| V | 0.54 |
| Zn | 0.72 |

Advantageously, the container for liquid (preferably water) according to the present invention has also obtained the MOCA certification (acronym indicating Materials and Objects in Contact with Food), according to Article 16 of Reg CE 1935/2004, a certification which guarantees that the product may be suitable for contact with food.

Advantageously, the ceramic filter, the process for cleaning said ceramic filter, the process for producing said ceramic filter and the container for liquids comprising said ceramic filter, according to the present invention, have been shown to help people live a healthier lifestyle, through non-disposable but long-lasting products, promoting the consumption of tap water and eliminating 100% of plastics. The ceramic filter and the container for liquids comprising said ceramic filter, according to the present invention, advantageously give people the possibility of drinking pure, good and safe water, producing zero waste, through sustainable, long-lasting and completely plastic-free products.

What is claimed is:

1. A ceramic filter comprising composite material, wherein the composite material has a porosity comprised between 0.1 μm and 10 μm.

2. The ceramic filter of claim 1, wherein the composite material comprises: a mixture of semi-refractory clay, ground rice hull or sieved or ground wood sawdust, clinoptilolite, and colloidal silver.

3. The ceramic filter of claim 2, wherein the colloidal silver is in a concentration comprised between 30 ppm and 50 ppm.

4. A process for cleaning a ceramic filter, the process comprising:
providing the ceramic filter of claim 1;
bringing an acidic aqueous solution to a boiling temperature;
immersing the ceramic filter in said acidic aqueous solution brought to the boiling temperature;
leaving the ceramic filter immersed in the acidic aqueous solution brought to the boiling temperature for a time comprised between 5 and 10 minutes; and
removing the ceramic filter from the acidic aqueous solution and allowing the ceramic filter to dry.

5. The process of claim 4, wherein the acidic aqueous solution is an aqueous solution of citric acid and the boiling temperature is comprised between 90° C. and 110° C.

6. A process for producing a ceramic filter, the process comprising:
preparing a mixture of semi-refractory clay, ground rice hull or sieved or ground wood sawdust, and clinoptilolite;
mixing together water, the mixture of semi-refractory clay, the ground rice hull or the sieved or ground wood sawdust, and the clinoptilolite, so as to obtain a mixture;
inserting the mixture so obtained inside a mold and, through a press molding technique, obtaining an object;
detaching the object from the mold;
baking the object obtained and detached from the mold at a temperature comprised between 900° C. and 1100° C. for a period of time comprised between 19 hours and 20 hours;
preparing an aqueous suspension of colloidal silver;
immersing the object in the aqueous suspension of colloidal silver; and
extracting the object from the aqueous suspension of colloidal silver and allowing the object to dry so as to obtain the ceramic filter of claim 1.

7. A container for liquids comprising a main body, the main body comprising at least a first closable opening, and at least a second closable opening, wherein the at least a first closable opening and the at least a second closable opening are fluidically connected by a through cavity, wherein the at least a second closable opening is closed by a removable ceramic filter according to claim 1; wherein the container further comprises a hollow receptacle functionally attachable to and detachable from the main body at the at least a second opening closed by said removable ceramic filter; and wherein, when the hollow receptacle is attached to the main body, the at least a second opening and the removable ceramic filter occupy part of the through cavity of the hollow receptacle.

8. The container of claim 7, wherein the removable ceramic filter is coupled to a further ceramic filter comprising calcium sulfite, and wherein the further ceramic filter comprising calcium sulfite is placed within the through cavity.

9. The container of claim 7, wherein the at least a first closable opening is closed by a removable cap.

10. The container of claim 7, wherein the main body further comprises a rotatable ferrule indicating a sequence of numbers comprised between 1 and 50.
